(19) United States
(12) Patent Application Publication
(10) Pub. No.: US 2007/0067276 A1
(43) Pub. Date: Mar. 22, 2007

(54) Displaying stored content in a computer system portal window

(76) Inventor: Ilja Fischer, Heidelberg (DE)

Correspondence Address: FISH & RICHARDSON, P.C., PO BOX 1022, MINNEAPOLIS, MN, 55440-1022, US

(21) Appl. No.: 11/230,869

(22) Filed: Sep. 20, 2005

(51) Int. Cl. G06F 17/30

(52) U.S. Cl. 707/4

(57) ABSTRACT

A method of displaying stored content includes presenting, on a display device, a portal window that includes a data warehouse area dedicated to presenting data warehouse (DW) information retrieved by running a query in a data warehouse system. First DW information currently presented in the data warehouse area is retrieved using a first query that relates to a first object. The method comprises receiving a first input that a user makes under guidance of an input control located elsewhere in the portal window than in the DW area. The first input is associated with a second object. The method comprises determining, using the first input, a second query to be run in the DW system, the second query relating to the second object. Second DW information, retrieved by running the second query in the DW system, is presented in the DW area in response to receiving the first input.

### TECHNICAL FIELD

The description relates to displaying stored content in a portal window of a computer system.

### BACKGROUND

Almost all computer systems have user interfaces for providing data or other information to users. Such data may be the (partial) contents of a repository in the system, such as when the user initiates a query to extract database contents. The output may contain transactional data, such as the operational information that is processed in the backend of an enterprise resources planning (ERP) system. Transactional data may include items or objects, representing for example products, that are obtained as a result of executing a search that the user has specified. Another example is analytical data, which is output by a data warehouse system after processing the transactional data it has obtained from the ERP backend. The analytical data may include an electronic report that contains a bar chart for the cost savings associated with a specific product, to name one example. Data warehouse systems are sometimes configured so that they can present data in predefined reporting formats based on receiving a query that defines the identity of the data and the reporting format. A graphical user interface (GUI) can present the transactional data, or analytical data, or both.

### SUMMARY

The invention relates to displaying stored content in a portal window.

In a first general aspect, the invention comprises a method of displaying stored content in a portal window of a computer system. The method comprises presenting a portal window on a display device. The portal window includes a data warehouse area dedicated to presenting data warehouse information retrieved by running a query in a data warehouse system. First data warehouse information currently presented in the data warehouse area is retrieved using a first query that relates to a first object. The method comprises receiving a first input that a user makes under guidance of an input control located elsewhere in the portal window than in the data warehouse area. The first input is associated with a second object. The method comprises determining, using the first input, a second query to be run in the data warehouse system, the second query relating to the second object. The method comprises presenting second data warehouse information in the data warehouse area in response to receiving the first input. The second data warehouse information is retrieved by running the second query in the data warehouse system.

In selected embodiments, the second query is determined using an identifier for the second object that is provided upon receiving the first input. Determining the second query may comprise mapping the identifier for the second object to a data warehouse identifier associated with the second object. Determining the second query may comprise identifying in a repository a data warehouse identifier associated with the second object. The portal window may be configured for generally presenting transactional data, the data warehouse information may essentially consist of analytical data, and determining the second query using the first input may provide that the data warehouse area is updated based on the transactional data. The first input may be made in a specific context of the portal window, and the specific context may be used in determining the second query. The first input may be made upon the user selecting the second object in the portal window. The input control may be located in association with a list of objects resulting from a performed search, the list including the second object. The portal window may be configured to present one or more views generated by programs, the views containing data retrieved from content sources, and the data warehouse area may be located within a first view generated by a first program. The input control may be located in a second view generated by a second program. The portal window may be pattern based and generated by a program that includes an extension interface for accepting an additional program component for adding another pattern to the portal window, and the data warehouse area may be generated by the additional program component through the extension interface. The second query may be determined using an identifier for the second object that is provided upon receiving the first input, and the additional program component may further map the identifier for the second object to a data warehouse identifier associated with the second object. The second query may be determined using an identifier for the second object that is provided upon receiving the first input, and the additional program component may further provide a repository in which can be identified, in response to the first input, a data warehouse identifier that is associated with the identifier for the second object.

In a second general aspect, the invention comprises a computer system that comprises a data warehouse system from which data warehouse information is retrieved by running a query. The computer system comprises a display device displaying a portal window that includes a data warehouse area dedicated to presenting the data warehouse information. The portal window further includes an input control located elsewhere than in the data warehouse area. Upon receiving an input that a user makes under guidance of the input control, the computer system determines a query to be run in the data warehouse system to update the data warehouse area.

In selected embodiments, the portal window is configured for generally presenting transactional data from a backend of the computer system, wherein the data warehouse information essentially consists of analytical data, and determining the query provides that the data warehouse area is updated based on a change of context in the transactional data. The transactional data may include a list of objects resulting from a performed search, and the change of context may comprise the user selecting an object in the list.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a GUI for presenting information including data warehouse information;

FIG. 2 is a block diagram of a system for presenting information including data warehouse information in a GUI;

FIG. 3 is a flow chart of exemplary operations that a system may perform when presenting information including data warehouse information in a GUI;

FIG. 4 is another flow chart of exemplary operations; and

FIG. 5 is a block diagram of a general computer system.

Like reference numerals in the various drawings indicate like elements.

### DETAILED DESCRIPTION

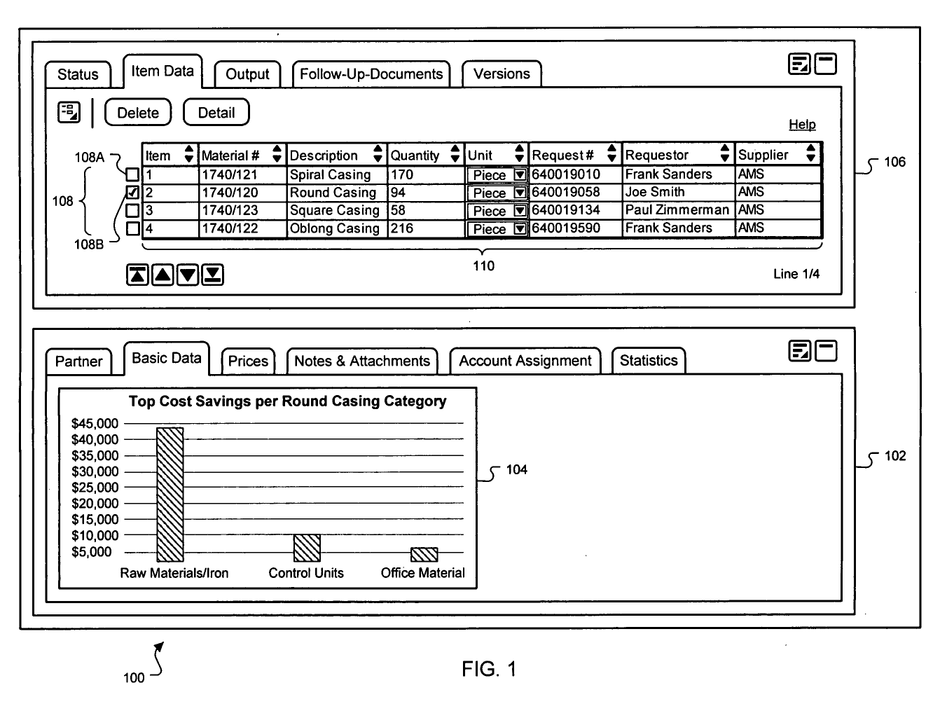

FIG. 1 shows a portal window 100 that serves as a GUI of a computer system. The portal window 100 includes a data warehouse area 102 dedicated to presenting data warehouse information, such as analytical data in the form of a report 104 depicting cost savings for a first object. The data warehouse information in the report 104 is retrieved by running, in a data warehouse system, a first query relating to the first object. The portal window 100 also contains a second area 106 having one or more input controls 108. The second area may have a context corresponding to any of several objects, including the first object.

A user may make an input in the input control(s) 108, such as by selecting a check box 108A, associated with a second object. Selecting the second object may change the context of the second area from the first object to the second object. A second query for the data warehouse system relating to the second object is determined using the input. In response to the input, second data warehouse information is presented in the data warehouse area 102. The second data warehouse information is retrieved by running the second query in the data warehouse system. Thus the data warehouse area may be updated based on the user selecting an object outside of the data warehouse area.

In some implementations, the second area 106 of the portal window is configured for presenting transactional data obtained directly from a backend or other source of transactional information. The second area 106 currently presents a list 110 of purchased materials. The list 110 represents objects contained in a repository of a data source system and is the result of a search performed in the repository.

Currently, a user has selected a first object corresponding to a “Round Casing” in the area 106. The selection is made using an input control 108B. The data warehouse area 102 currently presents corresponding data warehouse information relating to “Top Cost Savings per Round Casing Category,” which was retrieved from the data warehouse by running a first query. If the user selects, using an input control 108A, an object in the list 110 that corresponds to a “Spiral Casing,” the system will determine a second query, relating to the “Spiral Casing” object, to be run in the data warehouse system.

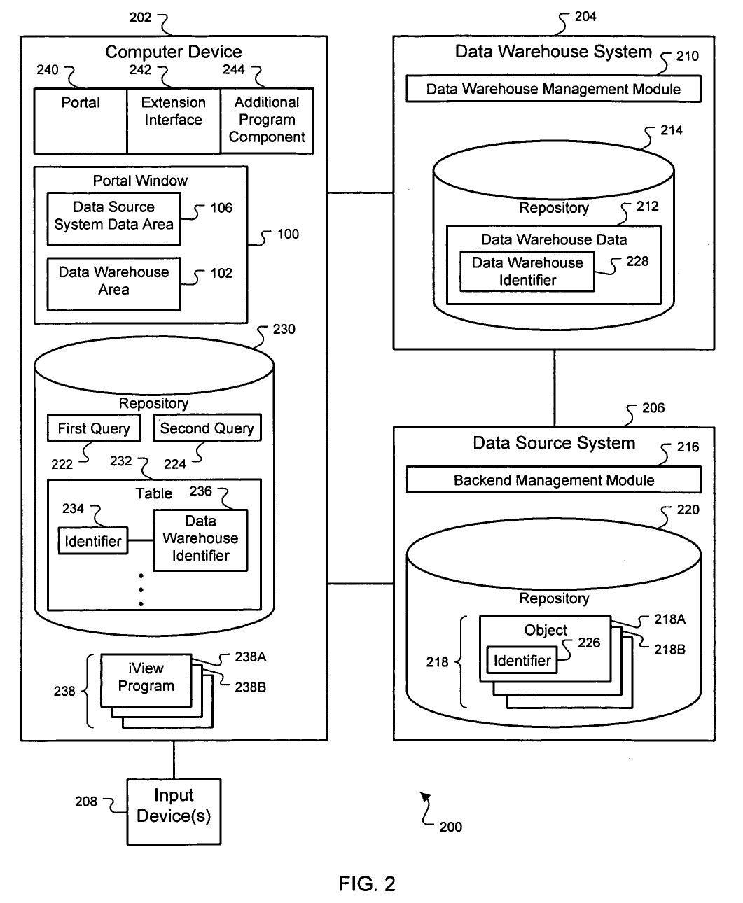

FIG. 2 shows a computer system 200 that can perform operations to display the portal window 100 of FIG. 1, among other functions. The system 200 includes a computer device 202 in communication with a data warehouse system 204 and a data source system 206 that are also in communication with each other. In addition, the computer device has access to input device(s) 208 by which the user can make inputs controlling what is presented in the portal window. For example, the data source system 206 may be operating as an ERP system in an organization and as such may generate transactional data that users may wish to access. Transactional data from the data source system 206 is replicated to the data warehouse system 204 from time to time. There, the information may be aggregated and processed to generate analytical data, for example key figure tabulations or other reporting tools that allow analysis of the ERP data. The computer device 202 has access to information both from the data source system 206 and the data warehouse system 204.

The data warehouse system 204 includes a data warehouse management module 210 that provides access to data warehouse data 212, such as analytical data, stored in a repository 214. Thus, the repository 214 contains the aggregated and processed data that was obtained from the data source system 206. The data source system 206 may include a number of application programs (not shown) that are executed to provide various ERP functions. In so doing, the application programs may use a large number of objects representing products, customers, etc. The data source system 206 therefore includes a backend management module 216 that provides access to objects 218 stored in a repository 220.

The computer device 202 is capable of displaying to the user the portal window 100 including the data warehouse area 102 and the second area, referred to here as data source system data area 106. The computer device 202 may retrieve the first data warehouse data displayed in the report 104 of FIG. 1 by running a first query 222 in the data warehouse system 204. The first query 222 and the first data warehouse data are associated with a first object 218B, “Round Casing,” in the repository 220.

After the user selects the check box 108A associated with the second object, “Spiral Casing,” a second query 224 is determined in response to the input. Upon the query being run, the second data warehouse data is presented in the data warehouse area 102. The second data warehouse data is retrieved by running the second query 224 in the data warehouse system 204. The second query 224 and the second data warehouse data are associated with a second object 218A, “Spiral Casing,” in the repository 220.

In some implementations, the second query 224 is determined using an identifier 226 of the “Spiral Casing” object 218A that is provided upon receiving the user input. Determining the second query 224 also comprises identifying a data warehouse identifier 228 that is used in the repository 214 as an identifier for the “Spiral Casing” object 218A in general, or specifically for any of the analytical data that is associated with the “Spiral Casing” object. The computer device 202 contains a repository 230, which stores a table 232 that maps object identifiers in the data source system 206 to data warehouse identifiers in the data warehouse system 204. The table 232 contains an identifier 234 of the “Spiral Casing” object 218A that is mapped to a data warehouse identifier 236 of the second data warehouse data 212. Determining the second query 224 comprises mapping the identifier 234, corresponding to the identifier 226 of the “Spiral Casing” object 218A, to the data warehouse identifier 236, corresponding to the data warehouse identifier 228 of the second data warehouse data 212.

In some implementations, iView Programs 238 generate the views that the portal window 100 presents in one or more of its areas. iView programs are used in some systems available from SAP AG in Walldorf (Bayern), Germany. The views contain data retrieved from different content sources. The data warehouse area 102 is located in a first view generated by a first iView Program 238A and contains data warehouse data retrieved from the data warehouse system 204. The data source system data area 106 is located in a second view generated by a second iView Program 238B and contains the objects 218 retrieved from the data source system 206 as well as the input controls 108. Accordingly, it may be provided that data warehouse content displayed using one iView is automatically updated upon the user changing the context of another iView that displays backend data.

In some implementations, the portal window 100 is pattern-based. A portal program 240 generates the pattern-based portal window 100. The patterns are formed by the respective areas that the portal window is configured to present. The portal program 240 is configured with some predefined functions and content and is capable of receiving additional customized functions and content. Particularly, the program 240 includes an extension interface 242 capable of accepting an additional program component 244 that adds a pattern, such as the data warehouse area 102, to the portal window 100. The additional program component 244 provides the data warehouse area 102 to the portal 240 through the extension interface 242. Particularly, the additional program component 244 may map the identifier 226 of the “Spiral Casing” object 218A received in the user input to the data warehouse identifier 228 of the second data warehouse data 212. For example, the additional program component 244 provides the repository 230 in which the mapping from the data warehouse identifier 228 to the object identifier 226 can be performed. Accordingly, the additional component may add a pattern for presenting data warehouse information, wherein information in the added pattern is automatically updated upon the user changing the context elsewhere in the portal window.

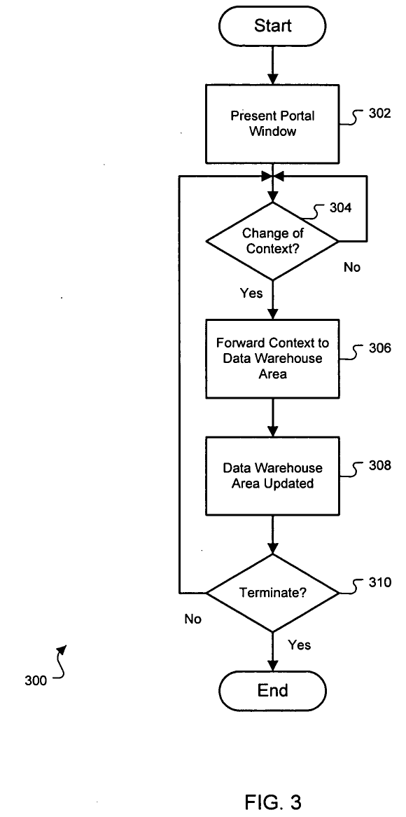

FIG. 3 is a flow chart of exemplary operations 300 that can be performed for displaying stored content in a portal window, for example by the system 200. A processor executing instructions stored in a computer program product can perform the operations 300. The operations 300 begin in step 302 with the presentation of a portal window on a display device. The portal window includes a data warehouse area dedicated to presenting data warehouse data retrieved using a query that relates to an object. For example, the portal program 240 presents the portal window 100.

In step 304, the operations determine whether there has been a change in context. For example, the data source system data area 106 has a context that is associated with an object displayed in the data source system data area 106. A user can change the context by making an input in the input controls 108. If it is determined in step 304 that no change of context has occurred, the operations 300 continue to check for a change of context. A new context may be received upon the user making an input, associated with a second object, under guidance of an input control located elsewhere in the portal window than in the data warehouse area. For example, the user selects the “Spiral Casing” object using the input control 108A. If there is a change in context, the operations 300 proceed to step 306. In step 306, the new context is forwarded to the data warehouse area. For example, after the user selects the check box 108A, the context of the “Spiral Casing” object 218A is passed to the data warehouse area 102. The context of the “Spiral Casing” object includes the “Spiral Casing” identifier 226. The new context is forwarded so that the data warehouse area can be updated with content corresponding to the new context. Particularly, there may be determined a second query to be run in the data warehouse system, the second query relating to the second object with which the user input is associated.

In step 308, the data warehouse area is updated to include data warehouse data associated with the new context. For example, the additional program component 244 uses the “Spiral Casing” identifier 226 to determine the data warehouse data 212 to retrieve from the data warehouse system 204 and updates the date warehouse area 102 with it.

In step 310, the operations 300 may terminate, such as by a termination command input from the user. If the operations 300 do not terminate, they return to step 304 where they continue to check for a change of context.

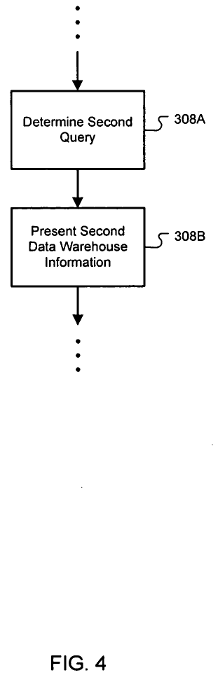

FIG. 4 shows sub-steps of the step 308 of FIG. 3. Step 308 here comprises a sub-step 308A where a second query is determined using the new context, the second query to be used in retrieving the data warehouse data for replacing the current data warehouse data, which was retrieved using the first query. For example, the additional program component 244 locates the “Spiral Casing” identifier 226, included in the new context, in the repository 230 to determine the second data warehouse identifier 228 to use in the second query 224. The repository 230 contains a mapping of the “Spiral Casing” identifier 234 to the second data warehouse identifier 236.

In step 308B, the second data warehouse information is presented in the data warehouse area. For example, the additional program component 244 runs the query determined in step 308A in the data warehouse system 204 to retrieve the second data warehouse data 212 and presents it to the user in the data warehouse area 102.

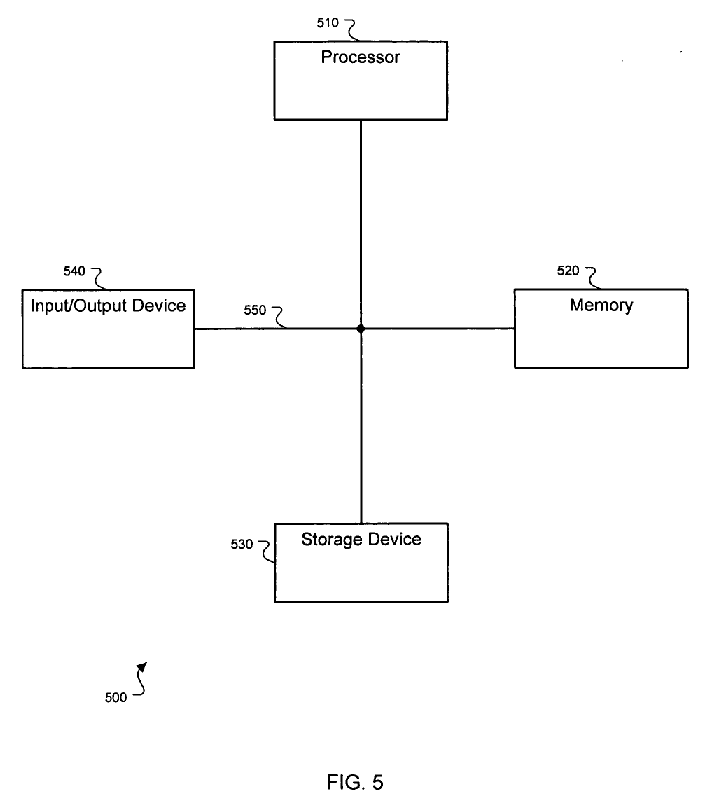

FIG. 5 is a block diagram of a computer system 500 that can be used in the operations described above, according to one embodiment. For example, the system 500 may be included in either or all of the computer device 202, the data warehouse system 204, and the data source system 206.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of displaying stored content in a portal window of a computer system, the method comprising:
presenting a portal window on a display device, the portal window including a data warehouse area dedicated to presenting data warehouse information retrieved by running a query in a data warehouse system, wherein first data warehouse information currently presented in the data warehouse area is retrieved using a first query that relates to a first object;
receiving a first input that a user makes under guidance of an input control located elsewhere in the portal window than in the data warehouse area, the first input being associated with a second object;
determining, using the first input, a second query to be run in the data warehouse system, the second query relating to the second object; and
presenting second data warehouse information in the data warehouse area in response to receiving the first input, the second data warehouse information being retrieved by running the second query in the data warehouse system.

2. The method of claim 1, wherein the second query is determined using an identifier for the second object that is provided upon receiving the first input.

3. The method of claim 2, wherein determining the second query comprises mapping the identifier for the second object to a data warehouse identifier associated with the second object.

4. The method of claim 2, wherein determining the second query comprises identifying in a repository a data warehouse identifier associated with the second object.

5. The method of claim 1, wherein the portal window is configured for generally presenting transactional data and the data warehouse information essentially consists of analytical data, and wherein determining the second query using the first input provides that the data warehouse area is updated based on the transactional data.

6. The method of claim 1, wherein the first input is made in a specific context of the portal window, and wherein the specific context is used in determining the second query.

7. The method of claim 1, wherein the first input is made upon the user selecting the second object in the portal window.

8. The method of claim 7, wherein the input control is located in association with a list of objects resulting from a performed search, the list including the second object.

9. The method of claim 1, wherein the portal window is configured to present one or more views generated by programs, the views containing data retrieved from content sources, and wherein the data warehouse area is located within a first view generated by a first program.

10. The method of claim 9, wherein the input control is located in a second view generated by a second program.

11. The method of claim 1, wherein the portal window is pattern based and generated by a program that includes an extension interface for accepting an additional program component for adding another pattern to the portal window, wherein the data warehouse area is generated by the additional program component through the extension interface.

12. The method of claim 11, wherein the second query is determined using an identifier for the second object that is provided upon receiving the first input, and wherein the additional program component further maps the identifier for the second object to a data warehouse identifier associated with the second object.

13. The method of claim 11, wherein the second query is determined using an identifier for the second object that is provided upon receiving the first input, and wherein the additional program component further provides a repository in which can be identified, in response to the first input, a data warehouse identifier that is associated with the identifier for the second object.

14. A computer-program product tangibly embodied in an information carrier, the computer-program product comprising instructions that, when executed, cause a processor to perform operations for displaying stored content in a portal window, the operations comprising:
presenting a portal window on a display device, the portal window including a data warehouse area dedicated to presenting data warehouse information retrieved by running a query in a data warehouse system, wherein first data warehouse information currently presented in the data warehouse area is retrieved using a first query that relates to a first object;
receiving a first input that a user makes under guidance of an input control located elsewhere in the portal window than in the data warehouse area, the first input being associated with a second object;
determining, using the first input, a second query to be run in the data warehouse system, the second query relating to the second object; and
presenting second data warehouse information in the data warehouse area in response to receiving the first input, the second data warehouse information being retrieved by running the second query in the data warehouse system.

15. A computer system comprising:
a data warehouse system from which data warehouse information is retrieved by running a query; and
a display device displaying a portal window that includes a data warehouse area dedicated to presenting the data warehouse information, the portal window further including an input control located elsewhere than in the data warehouse area;
wherein, upon receiving an input that a user makes under guidance of the input control, the computer system determines a query to be run in the data warehouse system to update the data warehouse area.

16. The computer system of claim 15, wherein the portal window is configured for generally presenting transactional data from a backend of the computer system, wherein the data warehouse information essentially consists of analytical data, and wherein determining the query provides that the data warehouse area is updated based on a change of context in the transactional data.

17. The computer system of claim 16, wherein the transactional data includes a list of objects resulting from a performed search, and wherein the change of context comprises the user selecting an object in the list.
